(19) United States
(12) Patent Application Publication
(10) Pub. No.: US 2008/0244075 A1
(43) Pub. Date: Oct. 2, 2008

(54) High performance real-time data multiplexer

(76) Inventors: Deh-Yung Kuo, Taipei (TW); Inn Nam Yong, Singapore (SG); Kee Chin Teo, Singapore (SG); Xudong Chen, Singapore (SG)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/731,042

(22) Filed: Mar. 29, 2007

(51) Int. Cl. G06F 15/16

(52) U.S. Cl. 709/227

(57) ABSTRACT

A method and system for enabling peer computers to communicate with each other is described. Data of varying data types from a plurality of data sources are multiplexed for delivery through at least one common peer connection.

### TECHNICAL FIELD

The disclosed embodiments relate generally to peer-to-peer communications in computer networks, and more specifically to aspects of delivering data through a data multiplexer.

### BACKGROUND

Currently, communications between a pair of peer-to-peer computers on a network require multiple open ports corresponding to the multiple data streams that are communicated between the given pair of peer-to-peer computers. Multiple open ports in a corporate firewall pose a significant security risk to the corporate network. Further, the delivery of data between peer-to-peer computers are based on first-in-first-out (FIFO) queues without consideration of the type of data being delivered. Further, peer computers sometimes share a common IP address using a restrictive NAT (network address translation) type, which increases the complexity of establishing peer-to-peer connections between peer computers.

### BRIEF DESCRIPTION OF THE DRAWINGS

FIG. 1 is a block diagram illustrating an exemplary distributed computer system, according to certain embodiments of the invention.

FIG. 2 is a high-level flowchart illustrating a method of communicating data sourced from several service type plug-ins from one peer computer to another peer computer.

FIG. 3 is a block diagram illustrating exemplary peer computers, according to certain embodiments of the invention.

FIG. 4 is a high-level flowchart illustrating a process for creating a connection between peer computers, according to certain embodiments of the invention.

FIG. 5 is a block diagram illustrating the architecture of the queuing control in relation to the filters and classes, according to certain embodiments.

FIG. 6 is a block diagram illustrating a hierarchical structure for classes associated with queuing control, according to certain embodiments.

FIG. 7 is a block diagram illustrating the order in which filters and their elements can be used for filtering a data packet, according to certain embodiments.

### DESCRIPTION OF EMBODIMENTS

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments of the invention, a computing system multiplexes data from a plurality of data sources associated with a first peer computer for delivery of data through at least one common peer connection from the first peer computer to a second peer computer during a session.

According to certain embodiments, the delivery of the data during a session is managed based on one or more factors such as service type of the data, the number of services associated with the session, available bandwidth during a session, user preference, etc.

According to certain embodiments, the at least one common peer connection at the first peer computer is used to deliver multiplexed data simultaneously to a plurality of peer computers.

According to certain embodiments, the at least one common peer connection at the first peer computer is used to receive data that is previously multiplexed at a second computer and the multiplexer/demultiplexer at the first peer computer demultiplexes the received data. According to certain embodiments, a multiplexer/demultiplexer at a given peer computer is used to simultaneously demultiplex a plurality of sets of multiplexed data received from corresponding peer computers.

According to one aspect, queuing control is used for managing delivery of data. Queuing control involves the use of one or more filters to enqueue data ready for transportation through the transport layer of the computer network.

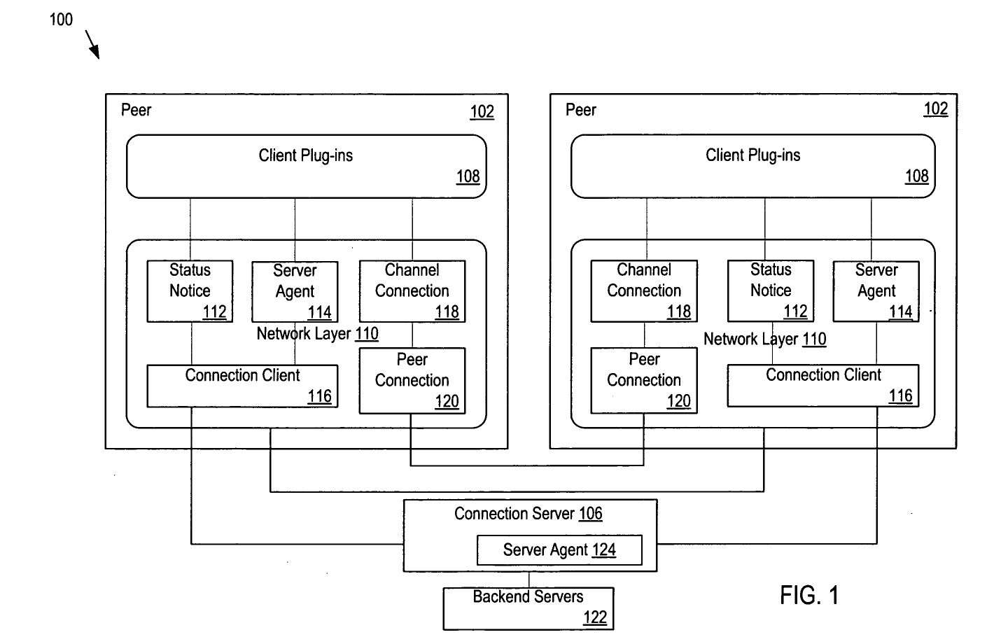

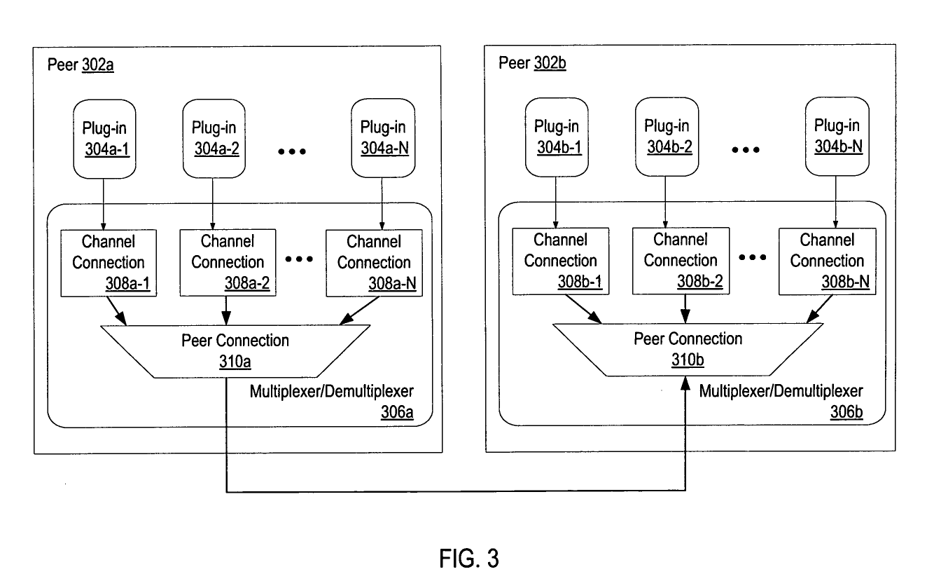

FIG. 1 is a block diagram illustrating an exemplary distributed computer system 100, according to certain embodiments of the invention. In FIG. 1, system 100 may include a plurality of peer computers 102, a connection server 106 and optionally one or more other servers, such as back end servers 122. Connection server 106 may access one or more databases (not shown in FIG. 1). Peer computers 102 can be any of a number of computing devices (e.g., desktop computers, Internet kiosk, personal digital assistant, cell phone, gaming device, laptop computer, handheld computer, or combinations thereof used to enable the activities described below. According to certain embodiments, peer computer 102 includes a plurality of client plug-ins 108, and a network layer 110. Network layer 110 includes a status/notice component 112, a client-side server agent 114, a connection client 116, and at least one data multiplexer. The data multiplexer includes a plurality of channel connections 118 corresponding to the plurality of plug-ins 108, and at least one peer connection 120. The data multiplexer is described in greater detail herein with reference to FIG. 3.

Connection server 106 may access back end servers 122 to retrieve or store information, for example. Back end servers 122 may include advertisement servers, status servers, accounts servers, database servers, etc. A non-limiting example of information that may be stored in backend servers include the profile and verification information of respective peer computers. According to certain embodiments, status servers broadcast information such as product or company announcements, status information, or information that is specific to certain groups of users.

According to certain embodiments, status/notice component 112 listens for information broadcast by connection server 106. Status/notice component 112 presents the broadcasted data at respective peer computers 102, through a user interface window, for example. Broadcast information may include advertisements from advertisement servers, status information from status servers, service announcements, news, etc. According to certain other embodiments, status/notice component 112 may request such information from connection server 106. In response, connection server 106 requests the information from the relevant backend servers in order to fulfill the request from the status/notice component 112. Upon receipt, the requested information may be displayed through the user interface window.

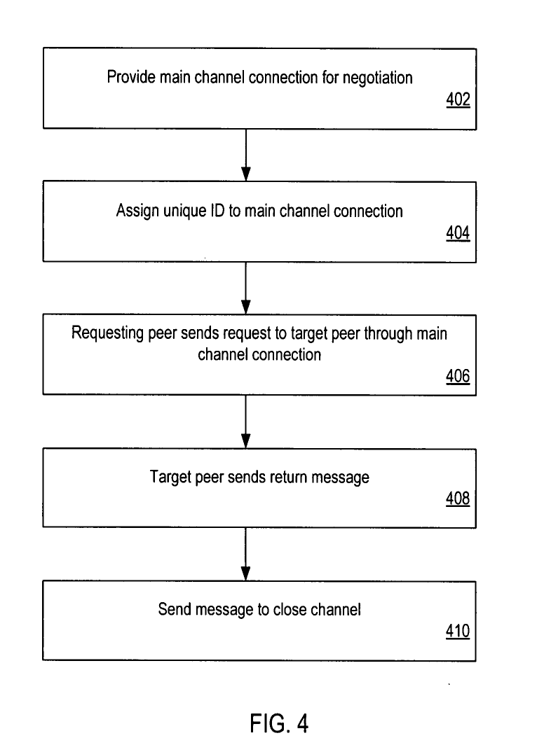

Connection server 106 includes a server agent 124. Peer computers 102 log on to connection server 106 before communicating with other peer computers. Connection server 106 introduces peer computers to one another, as described in greater detail herein with reference to FIG. 4. Peer computer 102 communicates with connection server 106 through client-side server agent 114 and the server-side server agent 124. According to certain embodiments, client side server agent 114 sends requests from peer computer 102 to connection server 106. Server agent 124 forwards such requests to the relevant components or servers.

Peer computers 102 are connected to connection server 106 via a communications network(s). In some embodiments, connection server 106 is a Web server or an instant messenger. Alternatively, if connection server 106 is used within an intranet, it may be an intranet server. In some embodiments, fewer and/or additional modules, functions or databases are included in peer computers 102 and connection server 106. The communications network may be the Internet, but may also be any local area network (LAN), a metropolitan area network, a wide area network (WAN), such as an intranet, an extranet, or the Internet, or any combination of such networks. It is sufficient that the communication network provides communication capability between the peer computers 102 and the connection server 106. The various embodiments of the invention, however, are not limited to the use of any particular protocol.

Notwithstanding the discrete blocks in FIG. 1, the figure is intended to be a functional description of some embodiments of the invention rather than a structural description of functional elements in the embodiments. One of ordinary skill in the art will recognize that an actual implementation might have the functional elements grouped or split among various components. Moreover, one or more of the blocks in FIG. 1 may be implemented on one or more servers designed to provide the described functionality. Although the description herein refers to certain features implemented in peer computer 102 and certain features implemented in connection server 106, the embodiments of the invention are not limited to such distinctions. For example, features described herein as being part of connection server 106 could be implemented in whole or in part in peer computer 102, and vice versa.

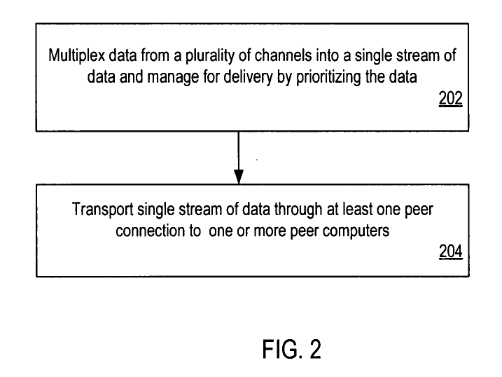

FIG. 2 is a high-level flowchart illustrating a method of communicating data sourced from several service type plug-ins from one peer computer to another peer computer. FIG. 2 shows that data from the plurality of data sources are multiplexed (merged) into a single stream of data and managed for delivery by prioritizing the data (202). The merged data is passed through at least one peer connection to one or more peer computers (204). According to certain embodiments, the data is prioritized for delivery based on one or more factors such as service type of the data, the number of services associated with the session, available bandwidth during a session, user preference, etc.

FIG. 3 is a block diagram illustrating exemplary peer computers, according to certain embodiments of the invention. FIG. 3 shows peer computer 302a in communication with peer computer 302b. Peer computer 302a includes at least one multiplexer/demultiplexer 306a, and a plurality of plug-ins 304a-1, 304a-2, . . . , 304a-N. Non-limiting examples of plug-ins include application-sharing plug-ins, video plug-ins, audio plug-ins, and text chat plug-ins. According to certain embodiments, multiplexer/demultiplexer 306a includes a plurality of channel connections 308a-1, 308a-2, . . . , 308a-N corresponding to the plurality of plug-ins 304a-1, 304a-2, . . . , 304a-N and a peer connection 310a. Similarly, peer computer 302b includes at least one multiplexer/demultiplexer 306b, and a plurality of plug-ins 304b-1, 304b-2, . . . , 304b-N. Non-limiting examples of plug-ins include application-sharing plug-ins, video plug-ins, audio plug-ins, and text chat plug-ins. Multiplexer/demultiplexer 306b includes a plurality of channel connections 308b-1, 308b-2, . . . , 308b-N corresponding to the plurality of plug-ins 304b-1, 304b-2, . . . , 304b-N and a peer connection 310b.

According to certain embodiments, a connection is created between peer computer 302a and 302b through peer connection 310a and 310b, respectively. For purposes of explanation, assume that peer computer 302a would like to pass data corresponding to several service types, such application-sharing, video, audio, etc., contemporaneously to peer computer 302b. The plurality of channel connections (308a-1, 308a-2, . . . , 308a-N) receive data from corresponding plug-ins (304a-1, 304a-2, . . . , 304a-N). Such multiple channel connections of data are merged into one stream when passed to peer connection 310a. The single stream of data is passed to peer connection 310b through a single connection between peer computer 302a and 302b. Peer computer 302b demultiplexes the single stream data received from peer computer 302a into respective channel types of data that is sent into the plurality of channel connections (308b-1, 308b-2, . . . , 308b-N) corresponding to the plurality of service type plug-ins (304b-1, 304b-2, . . . , 304b-N).

According to certain embodiments, the peer connection, such as peer connection 310a of 302a or peer connection 310b of 302b, may be used to connect to multiple peer computers simultaneously for communicating data. According to certain embodiments, the multiplexer/demultiplexer can demultiplex data received from multiple peer computers simultaneously.

According to certain embodiments, each of the plurality of channel connections at a given peer computer is assigned a local ID when it is registered with the network layer at the given peer computer. Thus, each channel connection associated with a channel name/service type at a given peer computer is assigned a local ID. For purposes of explanation, assume that a peer computer X opens a connection with another peer computer Y. When channel connections are opened at peer computer Y, the local IDs of the channel connections of peer computer X are transferred to peer computer Y and are referred to as remote channel connection IDs. Because peer computer X and peer computer Y may each assign a different local ID to the same channel name/service type, a map from local ID to remote ID is maintained, according to certain embodiments. Thus, if peer computer X opens connections with a plurality of peer computers, a plurality of maps from local ID to remote ID are maintained corresponding to each remote peer computer.

According to certain embodiments, in order to differentiate the data from different channels, the data from a respective channel is packaged into chunks for transmitting to a remote peer computer. According to certain embodiments, each chunk includes a header and a payload. Further, each chunk includes either the local channel ID information or the remote ID information. When a respective chunk is received at the target remote computer, the target computer maps the data chunks to corresponding remote channel ID. Thus, the received data is demultiplexed, and the demultiplexed data is sent to the appropriate plug-in at the target computer.

The following is a non-limiting example of a data chunk:

| Chunk Field | Type | Meaning |
|---|---|---|
| chid | 2B integer | Local Channel ID. |
| size | 2B integer | Content size in bytes. |
| content | Byte array | Chunk data. |

Before a connection is opened between peer computers, the connection server first introduces the peer computers to one another. FIG. 4 is a high-level flowchart illustrating a process for creating a connection between peer computers, according to certain embodiments of the invention. According to certain embodiments, a main channel connection is provided for allowing the network layer of one peer computer (requesting peer) to negotiate channel connections with that of another peer computer (target peer) (402). According to certain embodiments, the main channel connection is assigned a unique ID, such as ID_0, as a non-limiting example (404). Using the main channel connection, the requesting peer can send a request to the target peer to open one or more channel connections (406). For example, the requesting peer sends a message that includes the local channel ID and channel name. In response, the target peer can return message that accepts the request to open the respective channel connection (408). For example, the return message can include local channel ID and channel name associated with the channel connection that will be opened at the target peer. Such a process can be repeated for each channel connection to be opened. At such time when a channel connection is to be closed, a message that includes the channel name of the channel connection to be closed can be sent from one peer computer to other (410).

The following are non-limiting examples of messages, according to certain embodiments.

| Message Field | Type | Meaning |
|---|---|---|
| Key | 2B integer | Number identifies the message. |
| Length | 2B integer | Length of Value in bytes. |
| Value | Byte array | Value interpretation depends on Key. |

| Message | Key | Value Type | Function |
|---|---|---|---|
| Version | 1 | ASCII string | Major.Minor.Build. |
| | | | If not supported, disconnect. |
| Open-Channel- | 10 | 2B integer + | Local Channel ID + Channel |
| Connection | | UTF-8 string | Name. |
| | | | Request to open a channel |
| | | | connection. |
| Accept-Channel- | 11 | 2B integer + | Local Channel ID + Channel |
| Connection | | UTF-8 string | Name. |
| | | | Accept request to open a channel |
| | | | connection. |
| Close-Channel- | 12 | UTF-8 string | Channel Name. |
| Connection | | | Close a channel connection. |

According to certain embodiments, the multiplexer is associated with an adaptive quality of service (QoS) engine. Some of the functions of the adaptive QoS engine include prioritizing the delivery of data, providing dedicated bandwidth, controlling jitter, and mitigating latency as needed by some real-time and interactive data. The prioritization of data delivery ensures that the data is delivered in a timely manner based on the type of data or service type. Further, certain types of data, such as video and/or audio data require minimal latency and jitter and thus may need dedicated bandwidth for delivery through the multiplexer. Techniques for dedication of bandwidth for specific data include techniques such as Hierarchical Token Bucket (HTB). HTB uses the concepts of tokens and buckets along with a class-based system and filters to allow for complex and granular control of traffic. With a complex borrowing model, HTB can perform a variety of sophisticated traffic control techniques. HTB allows the user to define the characteristics of tokens and buckets and allows the user to nest such buckets. When HTB is coupled with a classifying scheme, traffic can be controlled in a granular fashion.

According to certain embodiments, the adaptive QoS incorporates a set of runtime parameters during initialization for self-tuning and adaptation to the system's resources and bandwidth that are currently available. The runtime parameters include:
Service types used in a session: As a non-limiting example, assume that a given session uses 3 types of services, such as application sharing, video and text chat types. The application sharing, and video service types will receive higher priority for dedicated bandwidth allocation.
Available bandwidth in the system.
Predetermined priority for service types: For example, respective service types may be assigned a preset priority.
End user preference: For example, the user may specify tunable parameters such as video quality, etc.

Further, according to certain embodiments, a user interface is provided to enable a user to dynamically adjust the adaptive QoS settings during a given session.

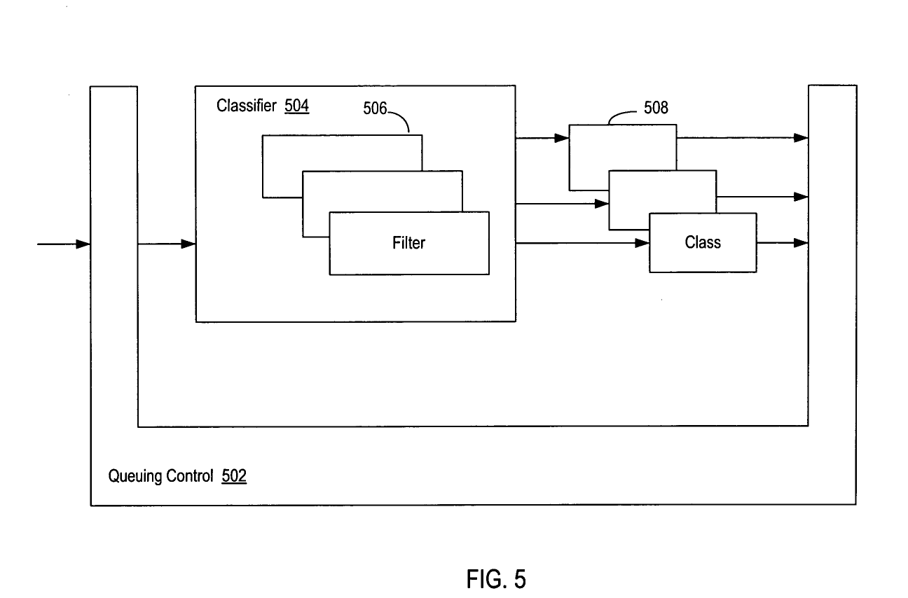

The adaptive QoS engine comprises: 1) a queuing control component, 2) classes, and 3) filters. FIG. 5 is a block diagram illustrating the architecture of the queuing control in relation to the filters and classes, according to certain embodiments. FIG. 5 shows a queuing control 502, a classifier 504, one or more filters 506 and a set of classes 508. Data is queued for delivery by first passing the data through classifier 504 for filtering through filters 506. Filters 506 assign the subsets of the data to relevant classes in the set of classes 508. Data packets that do not match the criteria in any of the filters are assigned to a default class, according to certain embodiments. Thus, queuing control enqueues data for delivery based on the classification of the data. Specific classes in the set of classes are designated for priority treatment. For example, the classes associated with application sharing or video may receive higher priority in the queue. Non-limiting examples of techniques used for controlling queuing include HTB and Stochastic Fairness Queuing (SFQ) queuing algorithms. The techniques used may vary from implementation to implementation.

According to certain embodiments, some of the functions of the queuing control component include:
enqueue function: The enqueue function enqueues a packet for delivery. If classes are used, the enqueue function first selects a class and then invokes the corresponding enqueue function of the inner queuing control associated with the class for further enqueuing.
dequeue function: The dequeue function returns the next packet that is eligible for imminent delivery. As an example, if the queuing control has no data packets to send, dequeue returns NULL.
requeue function: The requeue function puts a data packet back into the queue after dequeuing it with dequeue. The data packet will be queued at the same place from which it was removed by the dequeue function, for example. Requeueing may be needed due to a transmission error, etc.
initialization function: The initialization function initializes and configures the queuing control. Some of the runtime parameters that will affect the queuing control are provided through the initialization function.
reset function: The reset function returns the queuing control to its initial state. For example, the reset function clears the queues, etc. Further, the reset functions of corresponding queuing control associated with the respective classes are invoked.
destroy function: The destroy function removes a queuing control by removing all classes and filters, cancels all pending events and returns all resources held by the queuing control.
change function: The change function changes the configuration of a queuing control. Runtime parameters that affect the queuing control during an active session are provided through this function.
dump function: The dump function returns diagnostic data used for maintenance. The dump function returns relevant state variables and configuration information.

According to certain embodiments, the queuing control component waits until it is polled through the dequeue function. Thus, the dequeue function is invoked to forward the data packets to the transport layer.

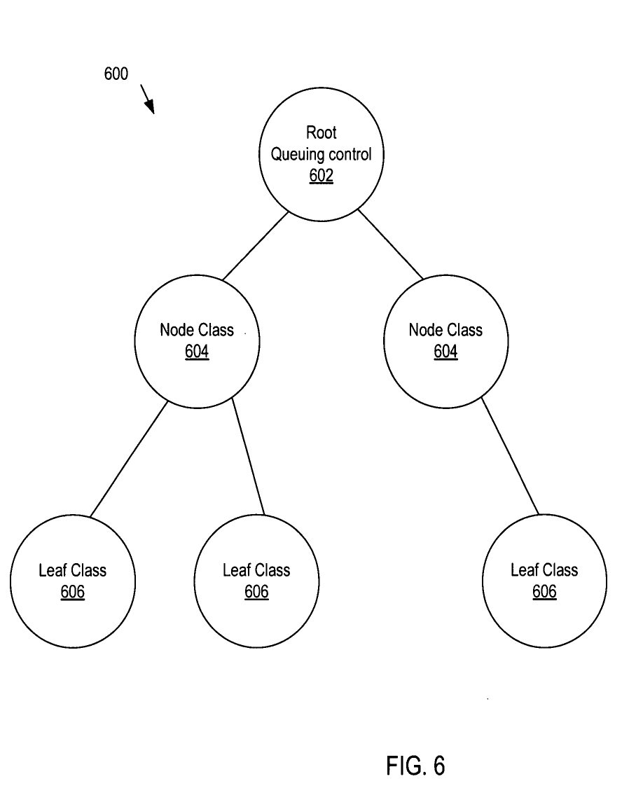

FIG. 6 is a block diagram illustrating a hierarchical structure for classes associated with queuing control, according to certain embodiments. FIG. 6 shows a hierarchy 600 for classes associated with queuing control. Hierarchy 600 includes a root queuing control 602, node classes 604, and leaf classes 606. Each node class handles a service type. Each node class and leaf class owns its own queue. As a non-limiting example, the node class uses a Hierarchical Token Bucket queue and the leaf class uses a Stochastic Fairness Queuing queue. When applying queuing control to a respective data packet, the adaptive QoS process starts at root 602 and traverses down the tree to visit the nodes. At each node, the one or more filters associated with the node class are consulted to determine if there is a class match for the data packet. In other words, the one or more filters return a decision to the queuing control at the node class. Based on the returned decision, the queuing control either enqueues the respective data packet to the current class or sends the data packet to another node class for further processing. In some cases, the decision at a node class may cause the data packet to be referred to a leaf class. When a respective data packet is referred to a leaf class, the data packet is enqueued to that leaf class. According to certain embodiments, if no class match is found for a respective data packet, the data packet is matched to a default class. For example, the default class may the class associated with the last node class visited.

When the enqueue function of the queuing control is called, the filters are applied to the data packet to determine the class to which the data packet belongs. Next, the enqueue function of the queuing control that is owned by the respective class is called.

A node class is the parent of a leaf class that represents a slot. A service type normally refers to a data type that the data multiplexer processes. A slot is a sub division of a service type. For example, for the video service type, if there are two cameras that are the source of the video, then video data from each camera will take up a different slot.

When initializing a node class, the following rate parameters are configured, according to certain embodiments:
GRate: The GRate is the data rate that a respective class and its descendants are guaranteed.
CeilRate: The CeilRate is the maximum rate at which a respective class can send data, if its parent node has available bandwidth.

The amount of bandwidth assigned to a respective class corresponds to at least the GRate. For node classes that are parents of other node classes, the amount of bandwidth is at least the amount at the GRate plus the sum of the amount requested by its children. The CeilRate parameter specifies the maximum bandwidth that a class can use. This limits the amount of bandwidth a respective class can borrow.

HTB queuing algorithm uses bandwidth up to the configured bandwidth. If more bandwidth is offered, only the excess is subject to the configured overlimit action. Such a feature is useful for systems with high bandwidth usage. HTB queuing will only take up a portion of the total bandwidth during peak usage, and will borrow excess bandwidth when more bandwidth is available.

According to certain embodiments, filters are used by the queuing control to assign incoming data packets to respective classes. Filtering begins when the enqueue function of the queuing control is invoked. Queuing control maintains filter lists to keep track of the filters. Filter lists are ordered by priority, in ascending order, for example. According to certain embodiments, a filter has an internal structure that is used to control internal elements, such as selection criteria, to determine if a respective data packet can be matched to a class.

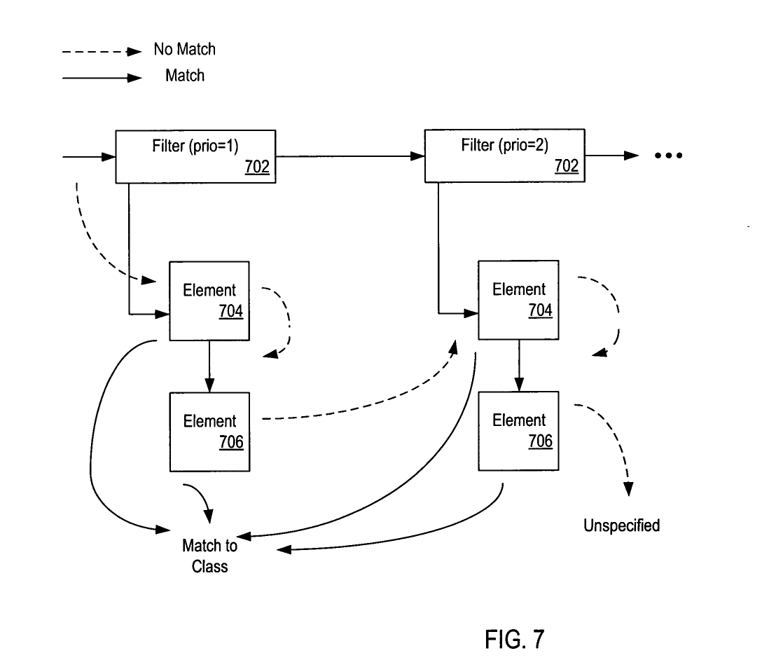

FIG. 7 is a block diagram illustrating the order in which filters and their elements can be used for filtering a data packet, according to certain embodiments. FIG. 7 shows a plurality of filters 702 and elements 706. A linked list that is processed sequentially is one non-limiting example of an internal structure of a filter. In FIG. 7, the dotted line arrows indicate the flow when no match is found for matching the respective data packet to a class. The solid line arrows indicate the flow when a match is found that matches the respective data packet to a class. The filters are provided information that is specific to the respective incoming data packet. As a non-limiting example, the channel-id, slot-id, and a priority map associated with the data packet are provided to the various filters. Such information is provided to help the filters match the respective data packet with an appropriate class. The embodiments are not limited to linked lists for filters. Other implementations of filters include hash tables, tree structures, or other structures that are suitable for the specific filter.

The priority map is a piece of data that determines the priority of the data packet that is being filtered. According to certain embodiments, the priority data may have the following structure.

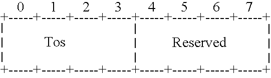

As a non-limiting example, the four TOS bits are defined as:

| Binary | Decimal | Meaning |
|---|---|---|
| 1000 | 8 | Minimize delay (md) |
| 0100 | 4 | Maximize throughput (mt) |
| 0010 | 2 | Maximize reliability (mr) |
| 0001 | 1 | Minimize monetary cost (mmc) |
| 0000 | 0 | Normal Service |

In the foregoing specification, embodiments of the invention have been described with reference to numerous specific details that may vary from implementation to implementation.

We claim:

1. A method for peer-to-peer communication, the method comprising:
multiplexing data from a plurality of data sources associated with a first peer computer for delivery of the data through at least one common peer connection at the first peer computer to at least a second peer computer of a plurality of peer computers during a session; and
managing delivery of respective data.

2. The method of claim 1, further comprising:
contemporaneously delivering the data through the at least one common peer connection at the first peer computer to a plurality of peer computers.

3. The method of claim 1, further comprising:
demultiplexing the data at the at least one second peer computer for associating with corresponding applications associated with the at least one second peer computer.

4. The method of claim 1, further comprising:
contemporaneously demultiplexing a plurality of sets of multiplexed data at the at least one second peer computer, the plurality of sets of multiplexed data received from the plurality of peer computers.

5. The method of claim 1, wherein the data from the plurality of data sources includes text, voice, video, audio, appshare data, binary data, and texture data.

6. The method of claim 1, further comprising multiplexing data from the plurality of data sources associated with the first peer computer for delivery of the data to the plurality of peer computers through corresponding plurality of common peer connections at the first peer computer.

7. The method of claim 1, further comprising multiplexing data from the plurality of data sources associated with the first peer computer for delivery of the data through the at least one common peer connection to the plurality of peer computers contemporaneously.

8. The method of claim 1, wherein managing delivery further comprises one or more selected from a group comprising:
dynamically prioritizing the delivery of data based on service type of the data;
dynamically prioritizing the delivery of data based on number of services associated with the session; and
dynamically prioritizing the delivery of data based on availability of bandwidth during the session.

9. The method of claim 1, wherein managing delivery is based on one or more criteria selected from a group consisting of:
respective pre-selected priority associated with a service type; and
user preference associated with delivery of selected data.

10. The method of claim 1, further comprising communicating with a plurality of servers.

11. The method of claim 1, further comprising using queuing control for managing the delivery of respective data.

12. The method of claim 11, further comprising using one or more filters to enqueue respective data.

13. The method of claim 1, further comprising using a channel connection to interface between a respective data source and the at least one common peer connection.

14. The method of claim 13, further comprising organizing the data into data chunks and associating each data chunk with a channel id of a respective channel connection through which the data chunk is passed.

15. A system for peer computer-to-peer computer communication, the system comprising:
a plurality of channel connections at a first peer computer of a plurality of peer computers;
at least one peer connection at the first peer computer for performing at least one of a group consisting of:
receiving first data from the plurality of channel connections;
sending second data to the plurality of channel connections;
connecting with at least one second peer computer; and
a quality of service engine associated with delivery of the data to a second peer computer.

16. The system of claim 15, further comprising:
one or more servers associated with managing peer profile information, accounting information, advertising information and software versioning information;
at least one connection server for performing at least one of a group consisting of:
introducing the first peer computer to the second peer computer; and
communicating with the one or more servers.

17. The system of claim 15, further comprising:
at least one connection server for causing at least one of a group consisting of:
provisioning upgrades and patches;
coordinating load balancing activities;
broadcasting advertising information to the plurality of peer computers; and
coordinating accounting activities.

18. The system of claim 16, further comprising:
at least one client server agent associated with a respective peer computer for communicating with the at least one connection server; and
at least one connection server agent associated with the at least one connection server for communicating with the one or more servers and the plurality of peer computers.

19. The system of claim 15, further comprising respective mapping information associated with a respective peer computer for mapping data that is received to corresponding applications at the respective peer computer.

20. The system of claim 15, wherein the quality of service engine includes respective components associated with one or more of a group consisting of:
dynamic prioritization of the delivery of data based on service type of the data;
dynamic prioritization of the delivery of data based on number of services associated with the session; and
dynamic prioritization of the delivery of data based on availability of bandwidth during the session

21. The system of claim 15, further comprising one or more filters to enqueue respective data.

22. The system of claim 15, wherein the at least one peer connection at the first peer computer connects with a plurality of peer computers, simultaneously.
